(19) United States
(12) Patent Application Publication
(10) Pub. No.: US 2021/0323544 A1
(43) Pub. Date: Oct. 21, 2021

(54) METHOD AND APPARATUS FOR VEHICLE DRIVING ASSISTANCE

(71) Applicant: BOE TECHNOLOGY GROUP CO., LTD., Beijing (CN)

(72) Inventors: Zhengong ZHAO, Beijing (CN); Dandan FENG, Beijing (CN)

(21) Appl. No.: 16/330,932

(22) PCT Filed: Aug. 24, 2018
(86) PCT No.: PCT/CN2018/102184

§ 371 Date: Mar. 6, 2019

(30) Foreign Application Priority Data
Jan. 31, 2018 (CN) 201810092689.3

(51) Int. Cl. B60W 30/095; B60W 30/18; B60W 40/072; B60W 40/105; B60W 50/14

(52) U.S. Cl. CPC B60W 30/0956; B60W 30/18163; B60W 30/18145; B60W 40/072; B60W 40/105; B60W 2556/65; B60W 2050/143; B60W 2050/146; B60W 2520/06; B60W 2520/10; B60W 50/14

(57) ABSTRACT

Embodiments of the present disclosure provide a method and an apparatus for vehicle driving assistance and a method and an apparatus for use in a vehicle. In the method for vehicle driving assistance, a driving assistance request is received from a first vehicle, and first vehicle information of the first vehicle is obtained. The first vehicle information at least includes a current location of the first vehicle. Second vehicle information is obtained based on the current location of the first vehicle. The second vehicle information is related to at least one vehicle entering the same curve lane or ramp as the first vehicle. A driving advice is provided to the first vehicle based on the first vehicle information and the second vehicle information.

### CROSS REFERENCE TO RELATED APPLICATIONS

This patent application is a National Stage Entry of PCT/CN2018/102184 filed on Aug. 24, 2018, which claims the benefit and priority of Chinese Patent Application No. 201810092689.3 filed on Jan. 31, 2018, the disclosures of which are incorporated by reference herein in their entirety as part of the present application.

### BACKGROUND

The present disclosure relates to the field of vehicle security, and more particularly, to a method and an apparatus for vehicle driving assistance and a method and an apparatus for use in the vehicle.

As the number of vehicles is increasing, the number of traffic accidents also shows an upward trend. Some of these traffic accidents are caused by road conditions. For example, traffic accidents that vehicles traveling in opposite directions collide with each other may occur on curve lanes or ramps. In such a traffic accident, a driver of a vehicle cannot know the condition of the road ahead in advance, thus cannot take corresponding actions in time, such as deceleration, changing lanes and so on, and thus the vehicle may collide with another vehicle coming from the opposite direction, thereby causing the traffic accident.

### BRIEF DESCRIPTION

Embodiments described herein provide a method and an apparatus for vehicle driving assistance and a method and an apparatus for use in the vehicle, which can contribute to preventing vehicles entering the same curve lane or ramp from colliding.

A first aspect of the present disclosure provides a method for vehicle driving assistance. In this method, a driving assistance request is received from a first vehicle. Next, first vehicle information of the first vehicle is obtained. The first vehicle information at least includes a current location of the first vehicle. Next, second vehicle information is obtained based on the current location of the first vehicle. The second vehicle information is related to at least one vehicle entering the same curve lane or ramp as the first vehicle. Next, a driving advice is provided to the first vehicle based on the first vehicle information and the second vehicle information.

In some embodiments of the present disclosure, the first vehicle information further includes a travel direction, a current speed, and a size of the first vehicle.

In some embodiments of the present disclosure, the second vehicle information includes a travel direction, a current location, a current speed, and a size of the at least one vehicle.

In some embodiments of the present disclosure, a distance between the at least one vehicle and the first vehicle is shorter than a predetermined distance.

In some embodiments of the present disclosure, in the step of providing the driving advice to the first vehicle based on the first vehicle information and the second vehicle information, a recommended speed of the first vehicle is determined, based on the respective travel directions, the current speeds and the current locations of the first vehicle and the at least one vehicle. Next, a recommended lane is determined for the first vehicle, based on the respective travel directions, the sizes and the current locations of the first vehicle and the at least one vehicle. Next, the recommended speed and the recommended lane are provided to the first vehicle.

In some embodiments of the present disclosure, the second vehicle information further includes a road image ahead of the at least one vehicle. This method further sends the road image ahead of the at least one vehicle to the first vehicle.

In some embodiments of the present disclosure, the first vehicle information further includes a first road image ahead of the first vehicle. The second vehicle information further includes a second road image ahead of the at least one vehicle. This method further performs an image registration on the first road image and the second road image with the same timestamp to generate a spliced image, and send the spliced image to the first vehicle.

In some embodiments of the present disclosure, the method further provides a driving advice to a selected vehicle of the at least one vehicle, based on the first vehicle information and information related to the selected vehicle in the second vehicle information.

In some embodiments of the present disclosure, the first vehicle information further includes a first road image ahead of the first vehicle. This method further sends the first road image to the selected vehicle.

In some embodiments of the present disclosure, the method further establishes a voice communication between the first vehicle and the at least one vehicle.

In some embodiments of the present disclosure, the method further receives a message from the first vehicle to disable the driving assistance.

A second aspect of the present disclosure provides a method for use in a vehicle. In this method, a road image ahead of the vehicle is obtained, and it is determined, based on the road image, whether the vehicle is about to enter a curve lane or a ramp. A driving assistance request is sent in response to the determination that the vehicle is about to enter the curve lane or the ramp. Next, a driving advice provided in response to the driving assistance request is received. Then, the driving advice is displayed.

In some embodiments of the present disclosure, the method further receives a second road image, and displays the first road image and the second road image at the same time.

In some embodiments of the present disclosure, the method further receives a second road image, performs an image registration on the road image and the second road image with the same timestamp to generate a spliced image, and displays the spliced image.

In some embodiments of the present disclosure, the method further sends a message to disable the driving assistance.

A third aspect of the present disclosure provides an apparatus for vehicle driving assistance. The apparatus includes at least one processor and at least one memory storing a computer program. The apparatus is configured to, when the computer program is executed by the at least one processor, perform the method for vehicle driving assistance according to the first aspect of the present disclosure.

A fourth aspect of the present disclosure provides an apparatus for use in a vehicle. The apparatus includes at least one processor and at least one memory storing a computer program. When the computer program is executed by the at least one processor, the apparatus is configured to obtain a road image ahead of the vehicle, determine, based on the road image, whether the vehicle is about to enter a curve lane or a ramp, send, in response to the determination that the vehicle is about to enter the curve lane or the ramp, a driving assistance request, receive a driving advice provided in response to the driving assistance request, and display the driving advice.

A fifth aspect of the present disclosure provides a system for vehicle driving assistance. The system includes the apparatus for vehicle driving assistance according to the third aspect of the present disclosure and the apparatus for use in the vehicle according to the fourth aspect of the present disclosure.

### BRIEF DESCRIPTION OF THE DRAWINGS

To describe technical solutions of the embodiments of the present disclosure more clearly, the accompanying drawings of the embodiments will be briefly introduced in the following. It should be known that the accompanying drawings in the following description merely involve some embodiments of the present disclosure, but do not limit the present disclosure, in which:

FIG. 1 is a schematic diagram illustrating a case where vehicles are travelling on a curve lane;

FIG. 2 illustrates an exemplary flowchart of a method for vehicle driving assistance according to an embodiment of the present disclosure;

FIG. 3 shows an exemplary schematic diagram for illustration of generating a spliced image based on image registration;

FIG. 4 is a schematic diagram illustrating another case where vehicles are travelling on a curve lane;

FIG. 5 illustrates an exemplary flowchart of a method for use in a vehicle according to an embodiment of the present disclosure;

FIG. 6 illustrates a schematic block diagram of an apparatus for vehicle driving assistance according to an embodiment of the present disclosure;

FIG. 7 illustrates an exemplary block diagram of an apparatus for use in a vehicle according to an embodiment of the present disclosure; and

FIG. 8 illustrates a schematic diagram of a system for vehicle driving assistance according to an embodiment of the present disclosure.

### DETAILED DESCRIPTION

To make the technical solutions and advantages of the embodiments of the present disclosure clearer, the technical solutions in the embodiments of the present disclosure will be described clearly and completely below, in conjunction with the accompanying drawings in the embodiments of the present disclosure. Obviously, the described embodiments are merely some but not all of the embodiments of the present disclosure. All other embodiments obtained by those skilled in the art based on the described embodiments of the present disclosure without creative efforts shall fall within the protecting scope of the present disclosure.

Unless otherwise defined, all terms (including technical and scientific terms) used herein have the same meaning as commonly understood by those skilled in the art to which present disclosure belongs. It will be further understood that terms, such as those defined in commonly used dictionaries, should be interpreted as having a meaning that is consistent with their meaning in the context of the specification and will not be interpreted in an idealized or overly formal sense unless expressly so defined herein. As used herein, the description of “connecting” or “coupling” two or more parts together should refer to the parts being directly combined together or being combined via one or more intermediate components.

In all embodiments of the present disclosure, terms such as “first” and “second” are only used to distinguish one element (or a part of the element) from another element (or another part of this element).

On a road such as a curve lane or a ramp where it is impossible to see vehicles ahead, a vehicle may collide with the vehicles ahead. A method and an apparatus for vehicle driving assistance provided by embodiments of the present disclosure may be used for assisting the vehicle on the above road to travel. Embodiments are illustrated below taking vehicle driving assistance for a vehicle on a curve lane as an example.

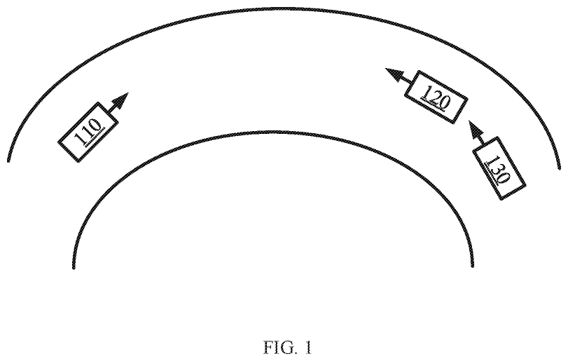

FIG. 1 is a schematic diagram illustrating a case where vehicles are travelling on a curve lane. As shown in FIG. 1, travel directions of a first vehicle 110, a second vehicle 120, and a third vehicle 130 are indicated by arrows. A driver in the first vehicle 110 may not see the second vehicle 120 and the third vehicle 130. Likewise, drivers in the second vehicle 120 and the third vehicle 130 may not see the first vehicle 110. Therefore, the first vehicle 110 may collide with the second vehicle 120 or the third vehicle 130. It is possible to sense vehicles on the curve lane by using ultrasonic or inter-vehicle communication technologies. However, if the mechanism for triggering the sense of the vehicles on the curve lane is not smart enough, it is necessary to manually trigger the sense of the vehicles on the curve lane or to keep turning on a mode of detecting surrounding vehicles, which may cause interference to daily driving. In addition, information shared between vehicles may only include locations, and thus it is necessary for the drivers to select vehicle lanes and vehicle speeds based on their own judgments.

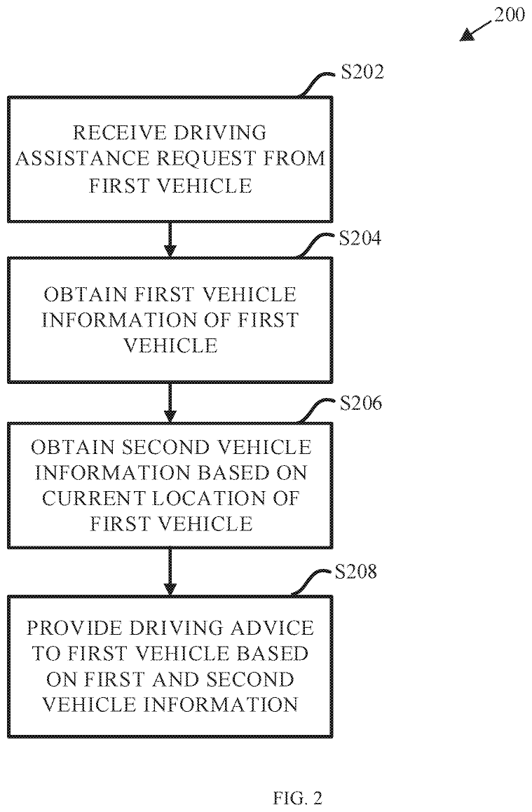

FIG. 2 illustrates an exemplary flowchart of a method 200 for vehicle driving assistance according to an embodiment of the present disclosure. In some embodiments of the present disclosure, the method for vehicle driving assistance may be performed by a computing device such as a cloud server located outside the vehicle. A vehicle expecting to obtain driving assistance may register with the computing device in advance, and allow the computing device to obtain information related to the vehicle. In some embodiments of the present disclosure, it is supposed that all involved vehicles have registered with the computing device. Embodiments are illustrated below taking the first vehicle 110 expecting to obtain driving assistance as an example.

As shown in FIG. 2, in step S202, the computing device may receive, from the first vehicle 110, a driving assistance request. The driving assistance request is used for requesting the computing device to assist the first vehicle 110 to travel on, for example, a curve lane or a ramp.

In step S204, the computing device may obtain first vehicle information of the first vehicle 110, wherein the first vehicle information at least includes a current location of the first vehicle 110. The first vehicle information may further include a travel direction, a current speed, and a size of the first vehicle.

In step S206, the computing device may obtain second vehicle information based on the current location of the first vehicle 110. The second vehicle information is related to at least one vehicle entering the same curve lane as the first vehicle 110. In some embodiments of the present disclosure, the computing device may search other registered vehicles within a search scope where a distance between them and the current location of the first vehicle 110 is shorter than a predetermined distance. The computing device may extend the search scope if no other vehicle is within the search scope. Embodiments are illustrated below by taking an example where the computing device finds the second vehicle 120 and the third vehicle 130. The computing device obtains the second vehicle information related to the second vehicle 120 and the third vehicle 130. The second vehicle information may include, for example, travel directions, current locations, current speeds, and sizes of the second vehicle 120 and the third vehicle 130.

In step S208, the computing device may provide a driving advice to the first vehicle 110 based on the first vehicle information and the second vehicle information. For example, the computing device may determine a recommended speed of the first vehicle 110, based on the respective travel directions, the current speeds, and the current locations of the first vehicle 110, the second vehicle 120, and the third vehicle 130. For example, the computing device may determine a recommended lane for the first vehicle 110, based on the respective travel directions, the sizes, and the current locations of the first vehicle 110, the second vehicle 120, and the third vehicle 130, to prevent the first vehicle 110 from travelling on the same vehicle lane as the second vehicle 120 and the third vehicle 130. Next, the computing device provides the recommended speed and the recommended lane to the first vehicle 110.

Further, in some embodiments of the present disclosure, the second vehicle information may further include, for example, road images ahead of the second vehicle 120 and the third vehicle 130. In such a case, the computing device may respectively receive, from the second vehicle 120 and the third vehicle 130, the road images (also referred to as “second road images”). The second vehicle 120 and the third vehicle 130 may capture conditions of road ahead by a vehicle-mounted camera to obtain the second road image. In the method 200 as shown in FIG. 2, the computing device may further send the second road image to the first vehicle 110. In this way, the driver in the first vehicle 110 may see, in advance, road condition which is able to be seen after the first vehicle 110 making a turn.

In further embodiments of the present disclosure, the first vehicle information may further include, for example, a road image ahead of the first vehicle 110. In such a case, the computing device may receive, from the first vehicle 110, the road image (also referred to as a “first road image”). The first vehicle 110 may capture conditions of road ahead by a vehicle-mounted camera to obtain the first road image. Here, the computing device and the vehicles (the first vehicle 110, the second vehicle 120, and the third vehicle 130) have synchronous clock signals. The vehicles may capture the road images at a predetermined time interval (such as one second), and may record, in metadata of the corresponding road images, the time (i.e., the timestamp) when the images are captured. Next, the vehicles may send the captured road images and the metadata thereof to the computing device. After receiving the first road image and the second road image, the computing device may perform an image registration on the first road image and the second road image with the same timestamp to generate a spliced image, and send the spliced image to the first vehicle 110. Performing an image registration on the first road image and the second road image with the same timestamp to generate a spliced image can avoid the problem of inaccurate registration caused by movement of the first vehicle 110 with respect to the second vehicle 120 and the third vehicle 130.

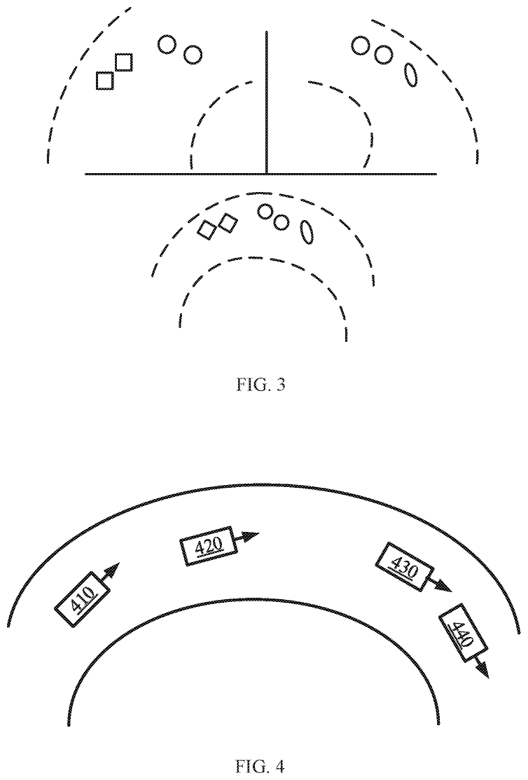

The image registration is a process of matching and superimposing two or more images obtained by different sensors (sensing devices) or obtained in different conditions (for example, capturing location or capturing angle and so on). FIG. 3 schematically shows a schematic diagram for illustration of generating a spliced image based on image registration. In FIG. 3, the embodiment is illustrated by taking images captured from the first vehicle 110 and the second vehicle 120 as an example. The image captured by the first vehicle 110 is exemplarily shown in the upper left corner of FIG. 3. The image captured by the second vehicle 120 is exemplarily shown in the upper right corner of FIG. 3. First, a feature extraction is performed on the image captured by the first vehicle 110 and the image captured by the second vehicle 120 to determine feature points of the two images. Next, a pair of matched feature points is determined based on a similarity measurement. Space coordinate transformation parameters of the images may be obtained based on the pair of matched feature points. An image registration may be performed on the two images based on the space coordinate transformation parameters, to generate a spliced image such as the image as shown at the bottom of FIG. 3. In the spliced image, the same part of the image in the upper left corner and the image in the upper right corner is merged to form an image with a broader field of view. For example, the image registration may be implemented by using a scale invariant feature transform (SIFT) algorithm in an OpenCV tool. Similarly, it is possible to splice images from the first vehicle 110, the second vehicle 120, and the third vehicle 130. By splicing images, drivers in the vehicles can know conditions of roads ahead more clearly.

Further, in some embodiments of the present disclosure, when an image is sent to the first vehicle 110, the computing device may also send an instruction indicating whether the image is a spliced image, such that the first vehicle 110 can know whether the image received is the spliced image or a second road image from other vehicle.

In some embodiments of the present disclosure, the computing device may also provide a driving advice to the second vehicle 120 and the third vehicle 130. For example, the computing device may determine a recommended speed of the second vehicle 120, based on the respective travel directions, the current speeds, and the current locations of the first vehicle 110, the second vehicle 120, and the third vehicle 130. The computing device may determine a recommended speed of the third vehicle 130, based on the respective travel directions, the current speeds, and the current locations of the first vehicle 110, the second vehicle 120, and the third vehicle 130. The computing device may determine a recommended lane for the second vehicle 120, based on the respective travel directions, the sizes, and the current locations of the first vehicle 110, the second vehicle 120, and the third vehicle 130, to prevent the second vehicle 120 from travelling on the same lane as the first vehicle 110. The computing device may determine a recommended lane for the third vehicle 130, based on the respective travel directions, the sizes, and the current locations of the first vehicle 110, the second vehicle 120, and the third vehicle 130, to prevent the third vehicle 130 from travelling on the same lane as the first vehicle 110. Next, the computing device may provide the recommended speed and the recommended lane to the second vehicle 120 and the third vehicle 130, respectively.

In some embodiments of the present disclosure, the computing device may also provide the first road image to the second vehicle 120 and the third vehicle 130. In this way, drivers in the second vehicle 120 and the third vehicle 130 may see roads which are able to be seen after the second vehicle 120 and the third vehicle 130 making a turn, to make driving judgments in advance.

In some embodiments of the present disclosure, the computing device may also establish a voice communication between the first vehicle 110 and the second vehicle 120 and a voice communication between the first vehicle 110 and third vehicle 130. Thus, the driver in the first vehicle 110 may carry out voice communications with the drivers in the second vehicle 120 and the third vehicle 130 to coordinate vehicle lanes and speeds mutually.

In some embodiments of the present disclosure, the computing device may also stop sending the driving advice to the first vehicle 110 after receiving a message from the first vehicle 110 to disable the driving assistance.

FIG. 4 illustrates another exemplary case where vehicles are travelling on a curve lane. In this exemplary case, the method for vehicle driving assistance according to embodiments of the present disclosure may also be implemented. As shown in FIG. 4, a fourth vehicle 410, a fifth vehicle 420, a sixth vehicle 430, and a seventh vehicle 440 are in the same travel direction, as indicated by arrows. In this example, it is supposed that the fourth vehicle 410 sends the driving assistance request to the computing device. In response to the driving assistance request, the computing device finds the fifth vehicle 420, the sixth vehicle 430, and the seventh vehicle 440.

The computing device may determine a recommended speed of the fourth vehicle 410, based on the respective travel directions, the current speeds and the current locations of the fourth vehicle 410, the fifth vehicle 420, the sixth vehicle 430, and the seventh vehicle 440. Further, the computing device may determine a recommended lane for the fourth vehicle 410, based on the respective travel directions, the sizes, and the current locations of the fourth vehicle 410, the fifth vehicle 420, the sixth vehicle 430, and the seventh vehicle 440. Next, the computing device may provide the fourth vehicle 410 with the recommended speed and the recommended lane as the driving advice, so as to prevent the fourth vehicle 410 from colliding with the fifth vehicle 420, the sixth vehicle 430, and the seventh vehicle 440. Furthermore, the computing device may also provide the recommended speed and the recommended lane to the fifth vehicle 420, the sixth vehicle 430, and the seventh vehicle 440, respectively.

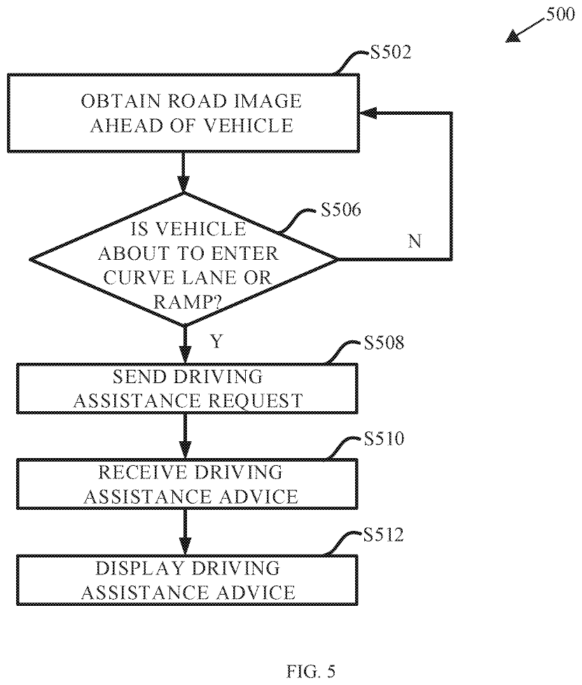

FIG. 5 illustrates an exemplary flowchart of a method 500 for use in a vehicle according to an embodiment of the present disclosure. The method 500 for use in the vehicle is described below taking the first vehicle 110 in FIG. 1 as an example.

As shown in FIG. 5, in step S502, a road image ahead of the vehicle is obtained. For example, the first vehicle 110 may obtain a first road image by using a camera installed in the front of the vehicle.

In step S506, it is determined whether a road ahead is a curve lane based on the first road image, so as to determine whether the first vehicle 110 is about to enter the curve lane. In some embodiments of the present disclosure, it is possible to recognize whether a road in the first road image is the curve lane by using an image recognition technology. In one embodiment, a curve lane recognition model may be pre-established. The curve lane recognition model may use a large number of curve lane images having been labeled as curve lanes, and the curve lane recognition model is established by training a neural network. After the first road image is obtained, it is recognized whether the road in the first road image is the curve lane by using the curve lane recognition model. Moreover, the curve lane may be recognized by using, for example, the SIFT algorithm integrated in the OpenCV tool. If it is determined that the road ahead is not the curve lane (“N” in step S506), which indicates that the vehicle will not enter the curve lane, the process returns to step S502 to continue to obtain the first road image. If it is determined that the road ahead is the curve lane (“Y” in step S506), which indicates that the vehicle is about to enter the curve lane, the driving assistance request is sent in step S508.

Alternatively, the driving assistance request may also be sent manually by the driver in the first vehicle 110 by pressing a button on the first vehicle 110. In some embodiments of the present disclosure, the button may be a button arranged on a control console of the vehicle or may be a touch button or a virtual button arranged on a vehicle-mounted touch screen.

Next, in step S510, the first vehicle 110 receives a driving advice provided in response to the driving assistance request. In step S512, the first vehicle 110 may display the received driving advice on a vehicle-mounted display. Thus, the driver in the first vehicle 110 may drive the first vehicle 110 based on the driving advice.

In some embodiments of the present disclosure, the first vehicle 110 may receive an image from an external device (such as the aforementioned computing device). In one embodiment, the first vehicle 110 may simultaneously display, on the vehicle-mounted display, the received image and the first road image. In another embodiment, when receiving an image from the external device, the first vehicle 110 receives an instruction indicating whether image is a spliced image. The first vehicle may determine, based on the received instruction, whether the received image is the spliced image. If the received image is the spliced image, the first vehicle 110 may directly display, on the vehicle-mounted display, the spliced image. If the received image is not the spliced image, the first vehicle 110 may simultaneously display, on the vehicle-mounted display, the first road image and the received image. Alternatively, the first vehicle 110 may also splice the received image with the first road image by using an image registration technology to generate a spliced image, and may display the spliced image on the vehicle-mounted display, so as to provide a broader field of view to the driver in the first vehicle 110.

Further, in some embodiments of the present disclosure, the first vehicle 110 may also determine, based on the first road image, whether the first vehicle 110 is about to be away from a curve lane. If it is determined that the first vehicle 110 is about to be away from the curve lane, the first vehicle 110 sends a message to disable the driving assistance. Alternatively, the driver in the first vehicle 110 may sent the message to disable the driving assistance via a button on the first vehicle 110, manually.

Further, the first vehicle 110 may also receive a driving advice provided in response to a driving assistance request from other vehicle. For example, in the case that the second vehicle 120 sends the driving assistance request to the computing device, the computing device may provide, to the second vehicle 120, the driving advice for the second vehicle 120. To prevent the first vehicle 110 from colliding with the second vehicle 120, the computing device may also provide, to the first vehicle 110, the driving advice for the first vehicle 110. Therefore, in such a case, even though the first vehicle 110 does not send the driving assistance request to the computing device, the first vehicle 110 may also receive the driving advice provided by the computing device.

FIG. 6 illustrates a schematic block diagram of an apparatus 600 for vehicle driving assistance according to an embodiment of the present disclosure. The apparatus 600 for vehicle driving assistance may be, for example, a cloud server, or may be implemented in the cloud server. As shown in FIG. 6, the apparatus 600 for vehicle driving assistance may include a processor 610 and a memory 620 storing a computer program. The apparatus 600 is configured to, when the computer program is executed by the processor 610, perform steps in the method 200 for vehicle driving assistance as shown in FIG. 2. That is, the apparatus 600 may receive, from the first vehicle 110, a driving assistance request. Next, the apparatus 600 may obtain first vehicle information of the first vehicle 110. The first vehicle information at least includes a current location of the first vehicle 110. Next, the apparatus 600 may obtain second vehicle information based on the current location of the first vehicle 110. The second vehicle information is related to at least one vehicle entering the same curve lane or ramp as the first vehicle 110. Next, the apparatus 600 may provide a driving advice to the first vehicle 110 based on the first vehicle information and the second vehicle information.

In some embodiments of the present disclosure, the apparatus 600 may determine a recommended speed of the first vehicle 110 based on the respective travel directions, the current speeds, and the current locations of the first vehicle 110 and the at least one vehicle, and may determine a recommended lane for the first vehicle 110 based on the respective travel directions, the sizes, and the current locations of the first vehicle 110 and the at least one vehicle. Next, the apparatus 600 may provide the recommended speed and the recommended lane to the first vehicle 110.

In some embodiments of the present disclosure, the second vehicle information further includes a road image ahead of the at least one vehicle. In such a case, the apparatus 600 may send, to the first vehicle 110, the road image ahead of the at least one vehicle.

In some embodiments of the present disclosure, the first vehicle information further includes a first road image ahead of the first vehicle 110, and the second vehicle information further includes a second road image ahead of the at least one vehicle. In such a case, the apparatus 600 may perform an image registration on the first road image and the second road image with the same timestamp to generate a spliced image, and send the spliced image to the first vehicle 110.

In some embodiments of the present disclosure, the apparatus 600 may also provide a driving advice to a selected vehicle of the at least one vehicle, based on the first vehicle information and information related to the selected vehicle in the second vehicle information. Further, the apparatus 600 may also send the first road image to the selected vehicle.

In some embodiments of the present disclosure, the apparatus 600 may also establish a voice communication between the first vehicle and the at least one vehicle.

In some embodiments of the present disclosure, the apparatus 600 may also receive, from the first vehicle, a message to disable the driving assistance.

Furthermore, in some embodiments of the present disclosure, the apparatus 600 may also include a sending device 630 configured to send the driving advice and the spliced image, etc. Moreover, the apparatus 600 may also include a receiving device 640 configured to receive the driving assistance request, the message to disable the driving assistance, etc. Further, the apparatus 600 may also include a communication device 650 configured to communicate with other communication devices.

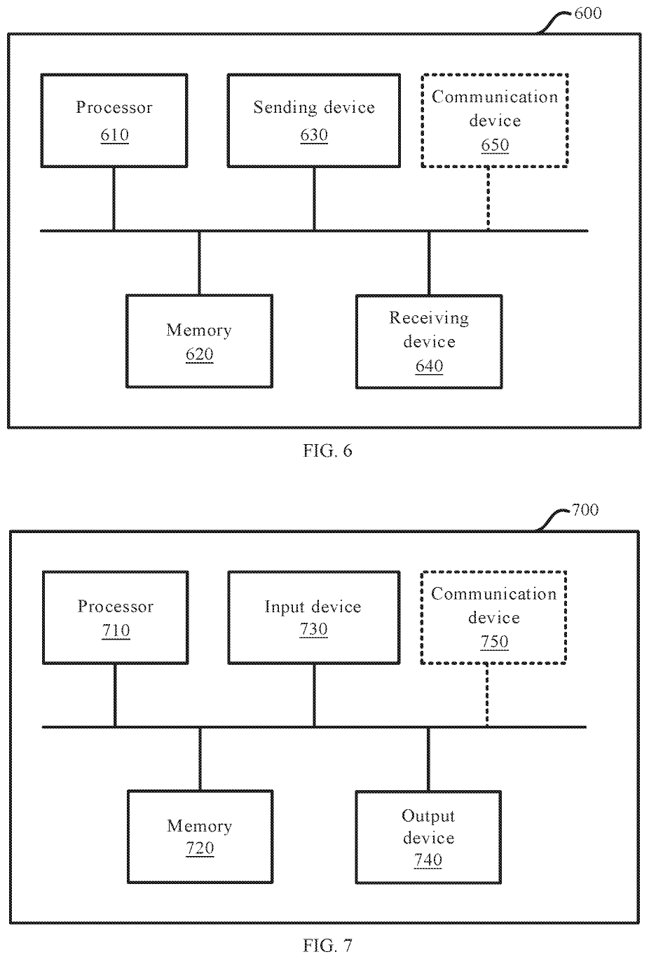

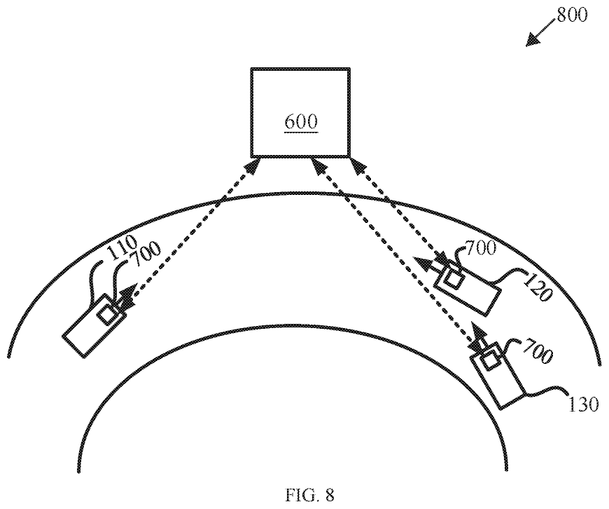

FIG. 7 illustrates an exemplary block diagram of an apparatus 700 for use in a vehicle according to an embodiment of the present disclosure. The apparatus 700 for use in the vehicle may be installed in, for example, a vehicle control system. The apparatus 700 for use in the vehicle may include a processor 710 and a memory 720 storing a computer program. The apparatus 700 is configured to, when the computer program is executed by the processor 710, perform steps of the method 500 for use in the vehicle as shown in FIG. 5. That is, the apparatus 700 may obtain a road image ahead of the vehicle, and may determine, based on the road image, whether the vehicle is about to enter a curve lane or a ramp. The apparatus 700 may send a driving assistance request in response to the determination that the vehicle is about to enter the curve lane or the ramp. Next, the apparatus 700 may receive a driving advice provided in response to the driving assistance request. Next, the apparatus 700 may display the driving advice.

Furthermore, in some embodiments of the present disclosure, the apparatus 700 may also include an input device 730 such as a keyboard, a touchscreen, a camera, etc. to obtain the road image, input the driving assistance request, and the like. Moreover, the apparatus 700 may also include an output device 740 such as a display, a loudspeaker, etc. to output the driving advice, the spliced image, the voice, and the like. Further, the apparatus 700 may also include a communication device 750 configured to communicate with other communication devices.

In some embodiments of the present disclosure, the processors 610 and 710 may be, for example, central processing units (CPUs), microprocessors, digital signal processors (DSPs), processors based on multi-core processor architectures, and so on. The memories 620 and 720 may be memories of any type that are implemented by using a data storage technology, including but not limited to random access memories, read-only memories, semiconductor-based memories, flash memories, magnetic disk memories, and so on.

Other embodiments of the present disclosure also provide a computer readable storage medium storing a computer program. When the computer program is executed by a processor, the steps of the method 200 for vehicle driving assistance as shown in FIG. 2 are performed.

Other embodiments of the present disclosure also provide a computer readable storage medium storing a computer program. When the computer program is executed by a processor, the steps of the method 500 for use in a vehicle as shown in FIG. 5 are performed.

FIG. 8 illustrates a schematic diagram of a system 800 for vehicle driving assistance according to an embodiment of the present disclosure. The system 800 for vehicle driving assistance includes, for example, the apparatus 600 for vehicle driving assistance as shown in FIG. 6 located in a cloud server and the apparatuses 700 for use in a vehicle as shown in FIG. 7 respectively located in the first vehicle 110, the second vehicle 120, and the third vehicle 130. The apparatus 600 for vehicle driving assistance may communicate with the apparatuses 700 for use in the vehicle via, for example, a wireless communication network (such as a 3G communication network, a 4G communication network, or a 5G communication network and so on) to assist the vehicle to travel.

In some embodiments of the present disclosure, in the system 800 for vehicle driving assistance, the apparatus 600 for vehicle driving assistance works collaboratively with the apparatuses 700 for use in the vehicle. In the case that the apparatus 600 for vehicle driving assistance provides the second road image to the apparatus 700 in the first vehicle 110, the first vehicle 110 may simultaneously display, on a vehicle-mounted display, the first road image and the second road image. Alternatively, the first vehicle 110 may splice, using an image registration technology, the second road image and the first road image to generate a spliced image. In the case that the apparatus 600 for vehicle driving assistance provides the spliced image to the apparatus 700 in the first vehicle 110, the first vehicle 110 may directly display the spliced image.

Those skilled in the art may understand that the method and the apparatus for vehicle driving assistance and the method and the apparatus for use in a vehicle according to embodiments of the present disclosure also can be used for assisting the vehicle to travel on a ramp.

As used herein and in the appended claims, the singular form of a word includes the plural, and vice versa, unless the context clearly dictates otherwise. Thus, singular words are generally inclusive of the plurals of the respective terms. Similarly, the words “include” and “comprise” are to be interpreted as inclusively rather than exclusively. Likewise, the terms “include” and “or” should be construed to be inclusive, unless such an interpretation is clearly prohibited from the context. Where used herein the term “examples,” particularly when followed by a listing of terms is merely exemplary and illustrative, and should not be deemed to be exclusive or comprehensive.

Further adaptive aspects and scopes become apparent from the description provided herein. It should be understood that various aspects of the present disclosure may be implemented separately or in combination with one or more other aspects. It should also be understood that the description and specific embodiments in the present disclosure are intended to describe rather than limit the scope of the present disclosure.

A plurality of embodiments of the present disclosure has been described in detail above. However, apparently those skilled in the art may make various modifications and variations on the embodiments of the present disclosure without departing from the spirit and scope of the present disclosure. The scope of protecting of the present disclosure is limited by the appended claims.

1. A method for vehicle driving assistance, the method comprising:
receiving, from a first vehicle, a driving assistance request;
obtaining first vehicle information of the first vehicle, the first vehicle information at least comprising a current location of the first vehicle;
obtaining second vehicle information based on the current location of the first vehicle, wherein the second vehicle information is related to at least one vehicle entering one of the same curve lane and ramp as the first vehicle; and
providing driving advice to the first vehicle based on the first vehicle information and the second vehicle information.

2. The method according to claim 1, wherein the first vehicle information further comprises a travel direction, a current speed, and a size of the first vehicle.

3. The method according to claim 1, wherein the second vehicle information comprises a travel direction, a current location, a current speed, and a size of the at least one vehicle.

4. The method according to claim 1, wherein a distance between the at least one vehicle and the first vehicle is shorter than a predetermined distance.

5. The method according to claim 1, wherein providing driving advice to the first vehicle based on the first vehicle information and the second vehicle information comprises:
determining a recommended speed of the first vehicle, based on the respective travel directions, the current speeds, and the current locations of the first vehicle and the at least one vehicle;
determining a recommended lane for the first vehicle, based on the respective travel directions, the sizes, and the current locations of the first vehicle and the at least one vehicle; and
providing the recommended speed and the recommended lane to the first vehicle.

6. The method according to claim 3, wherein the second vehicle information further comprises a road image ahead of the at least one vehicle, and wherein the method further comprises:
sending, to the first vehicle, the road image ahead of the at least one vehicle.

7. The method according to claim 3, wherein the first vehicle information further comprises a first road image ahead of the first vehicle, wherein the second vehicle information further comprises a second road image ahead of the at least one vehicle, and wherein the method further comprises:
performing an image registration on the first road image and the second road image with the same timestamp, to generate a spliced image; and
sending the spliced image to the first vehicle.

8. The method according to claim 1, the method further comprising:
providing additional driving advice to a selected vehicle of the at least one vehicle, based on the first vehicle information and information related to the selected vehicle in the second vehicle information.

9. The method according to claim 8, wherein the first vehicle information further comprises a first road image ahead of the first vehicle, and wherein the method further comprises:
sending the first road image to the selected vehicle.

10. The method according to claim 1, the method further comprising:
establishing a voice communication between the first vehicle and the at least one vehicle.

11. The method according to claim 1, the method further comprising:
receiving, from the first vehicle, a message to disable the driving assistance.

12. A method for use in a vehicle, the method comprising:
obtaining a road image ahead of the vehicle;
determining, based on the road image, whether the vehicle is about to enter one of a curve lane and a ramp;
sending, in response to the determination that the vehicle is about to enter one of the curve lane and the ramp, a driving assistance request;
receiving driving advice provided in response to the driving assistance request; and
displaying the driving advice.

13. An apparatus for vehicle driving assistance comprising:
at least one processor; and
at least one memory storing a computer program,
wherein the apparatus is configured to, when the computer program is executed by the at least one processor, perform the method according to claim 1.

14. An apparatus for use in a vehicle, the apparatus comprising:
at least one processor; and
at least one memory storing a computer program,
wherein when the computer program is executed by the at least one processor, the apparatus is configured to:
obtain a road image ahead of the vehicle;
determine, based on the road image, whether the vehicle is about to enter one of a curve lane and a ramp;
send, in response to the determination that the vehicle is about to enter one of the curve lane and the ramp, a driving assistance request;
receive driving advice provided in response to the driving assistance request; and
display the driving advice.

15. A system for vehicle driving assistance comprising the apparatus for vehicle driving assistance according to claim 13 and an apparatus for use in a vehicle, the apparatus for use in a vehicle comprising:
at least one processor; and
at least one memory storing a computer program,
wherein when the computer program is executed by the at least one processor, the apparatus for use in a vehicle is configured to:
obtain a road image ahead of the vehicle;
determine, based on the road image, whether the vehicle is about to enter one of a curve lane and a ramp;
send, in response to the determination that the vehicle is about to enter one of the curve lane and the ramp, a driving assistance request;
receive driving advice provided in response to the driving assistance request; and
display the driving advice.

16. The method according to claim 2, wherein providing driving advice to the first vehicle based on the first vehicle information and the second vehicle information comprises:
determining a recommended speed of the first vehicle, based on the respective travel directions, the current speeds, and the current locations of the first vehicle and the at least one vehicle;
determining a recommended lane for the first vehicle, based on the respective travel directions, the sizes, and the current locations of the first vehicle and the at least one vehicle; and
providing the recommended speed and the recommended lane to the first vehicle.

17. The method according to claim 3, wherein providing driving advice to the first vehicle based on the first vehicle information and the second vehicle information comprises:
determining a recommended speed of the first vehicle, based on the respective travel directions, the current speeds, and the current locations of the first vehicle and the at least one vehicle;
determining a recommended lane for the first vehicle, based on the respective travel directions, the sizes, and the current locations of the first vehicle and the at least one vehicle; and
providing the recommended speed and the recommended lane to the first vehicle.

18. The method according to claim 2, wherein the second vehicle information comprises a travel direction, a current location, a current speed, and a size of the at least one vehicle.

19. The method according to claim 18, wherein providing driving advice to the first vehicle based on the first vehicle information and the second vehicle information comprises:
determining a recommended speed of the first vehicle, based on the respective travel directions, the current speeds, and the current locations of the first vehicle and the at least one vehicle;
determining a recommended lane for the first vehicle, based on the respective travel directions, the sizes, and the current locations of the first vehicle and the at least one vehicle; and
providing the recommended speed and the recommended lane to the first vehicle.

20. The method according to claim 18, wherein the first vehicle information further comprises a first road image ahead of the first vehicle, wherein the second vehicle information further comprises a second road image ahead of the at least one vehicle, and wherein the method further comprises:
performing an image registration on the first road image and the second road image with the same timestamp, to generate a spliced image; and
sending the spliced image to the first vehicle.
